(19) United States
(12) Patent Application Publication
(10) Pub. No.: US 2022/0044573 A1
(43) Pub. Date: Feb. 10, 2022

(54) SERVER, NON-TRANSITORY COMPUTER READABLE MEDIUM, AND CONTROL METHOD

(71) Applicant: Toyota Jidosha Kabushiki Kaisha, Toyota-shi Aichi-ken (JP)

(72) Inventors: Changyi Luo, Kokubunji-shi Tokyo-to (JP); Ayana Takeshita, Kasugai-shi Aichi-ken (JP); Yuhei Suzuki, Kariya-shi Aichi-ken (JP); Michael C. Edwards, McKinney, TX (US); Chris Risberg, Flower Mound, TX (US)

(21) Appl. No.: 17/395,170

(22) Filed: Aug. 5, 2021

(30) Foreign Application Priority Data
Aug. 7, 2020 (JP) 2020-135361

(51) Int. Cl. G08G 1/00; B60W 30/165; B60W 30/14; B60W 40/105

(52) U.S. Cl. CPC G08G 1/202; G08G 1/205; G08G 1/22; B60W 2556/65; B60W 30/143; B60W 40/105; B60W 30/165

(57) ABSTRACT

A server is configured to communicably connect to a first vehicle and a second vehicle that includes a toilet unit. The server comprises a controller. The controller is configured to: receive from the first vehicle a request for vehicle dispatch; identify the second vehicle in response to the request for vehicle dispatch; obtain location information for the first vehicle; and cause the second vehicle to move to a location corresponding to the location information.

### CROSS-REFERENCE TO RELATED APPLICATION

This application claims priority to Japanese patent application No. 2020-135361 filed on Aug. 7, 2020, the entire disclosure of which is incorporated herein by reference.

### TECHNICAL FIELD

The present disclosure relates to a server, a program, and a control method.

### BACKGROUND

A technology that estimates the urge to urinate or defecate of a vehicle occupant and performs, based on an estimation result, vehicle occupant support control such as proposal of a toilet break or control of vehicle behavior, is known (for example, Patent Literature [PTL] 1).

### CITATION LIST

### Patent Literature

PTL 1: JP 2020-047022 A

### SUMMARY

Even if vehicle occupant support control is performed as described in the above-mentioned PTL 1, the urge to urinate or defecate is not relieved when a toilet is not in the vicinity of the vehicle. The vehicle occupant must drive to the toilet under strain in order to relieve the urge to urinate or defecate. Stopping by the toilet on the way to a destination can result in a detour.

It would be helpful to provide a server, a program, and a control method that enable use of a toilet while moving to a destination.

A server according to an embodiment of the present disclosure is configured to communicably connect to a first vehicle and a second vehicle. The second vehicle includes a toilet unit. The server includes a controller configured to:

receive from the first vehicle a request for vehicle dispatch;

identify the second vehicle in response to the request for vehicle dispatch;

obtain location information for the first vehicle; and

cause the second vehicle to move to a location corresponding to the location information.

A program according to an embodiment of the present disclosure is configured to cause a computer, communicably connected to a first vehicle and a second vehicle that includes a toilet unit, to execute operations, the operations including:

receiving from the first vehicle a request for vehicle dispatch;

identifying the second vehicle in response to the request for vehicle dispatch;

obtaining location information for the first vehicle; and

causing the second vehicle to move to a location corresponding to the location information.

A control method according to an embodiment of the present disclosure is performed by a server communicably connected to a first vehicle and a second vehicle that includes a toilet unit. The control method includes:

receiving from the first vehicle a request for vehicle dispatch;

identifying the second vehicle in response to the request for vehicle dispatch;

obtaining location information for the first vehicle; and

causing the second vehicle to move to a location corresponding to the location information.

The server, the program, and the control method according to embodiments of the present disclosure can enable use of a toilet while moving to a destination.

### BRIEF DESCRIPTION OF THE DRAWINGS

In the accompanying drawings:

FIG. 1 is a schematic diagram of an information processing system;

FIG. 2 is a block diagram illustrating a configuration of a first vehicle;

FIG. 3 is a block diagram illustrating a configuration of a second vehicle;

FIG. 4 is a block diagram illustrating a configuration of a server;

FIG. 5 is a diagram illustrating an interior of the first vehicle;

FIG. 6 is a diagram illustrating a data structure of a vehicle dispatch request DB (database);

FIG. 7 is a diagram illustrating an appearance of the first vehicle and the second vehicle when they are connected; and

FIG. 8 is a flowchart illustrating operation of the server.

### DETAILED DESCRIPTION

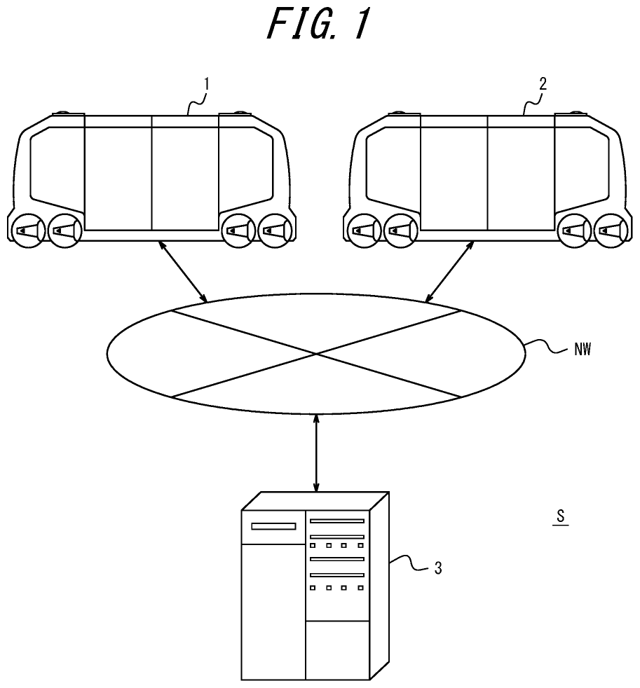

FIG. 1 is a schematic diagram of an information processing system S according to an embodiment. The information processing system S includes a first vehicle 1, a second vehicle 2, and a server 3, which are communicably connected to each other. In FIG. 1, a single first vehicle 1, a single second vehicle 2, and a single server 3 are illustrated for convenience of explanation. However, each the first vehicle 1, the second vehicle 2, and the server 3 is not limited to one in number. The first vehicle 1 and the second vehicle 2 have the same appearance in FIG. 1. However, as an alternative example, the first vehicle 1 and the second vehicle 2 may have a different appearance. The first vehicle 1, the second vehicle 2 and the server 3 are connected via a network NW including, for example, a mobile communication network and the Internet.

Each of the first vehicle 1 and the second vehicle 2 includes any type of automobile such as, for example, a gasoline vehicle, a diesel vehicle, an HV, a PHV, an EV, or an FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. Each of the first vehicle 1 and the second vehicle 2 is automated in its operation at any level in the present embodiment, but may be driven by a driver in other embodiments. The automation level is, for example, any one of Level 1 to Level 5 according to the level classification defined by SAE. The name “SAE” is an abbreviation of Society of Automotive Engineers. Each of the first vehicle 1 and the second vehicle 2 may be a MaaS-dedicated vehicle. The term “MaaS” is an abbreviation of Mobility as a Service.

The server 3 may assist provision of a vehicle dispatch service by a provider. The server 3 may be, for example, installed in a facility dedicated to the vehicle dispatch provider or in a shared facility that includes a data center. The server 3 transmits instructions to the first vehicle 1 or the second vehicle 2 to control the first vehicle 1 or the second vehicle 2. As an alternative example, the server 3 may be mounted on the first vehicle 1 or the second vehicle 2.

An outline of processing that is executed by the server 3 according to the present embodiment will be described. A controller 31 of the server 3 is communicably connected to the first vehicle 1 and the second vehicle 2 including a toilet unit 25. Upon receiving a request for vehicle dispatch from the first vehicle 1, the controller 31 responds to the request for vehicle dispatch and identifies the second vehicle 2. The controller 31, upon obtaining location information for the first vehicle 1 using, for example, GPS (Global Positioning System), causes the second vehicle 2 to move to a location corresponding to the location information. According to this configuration, the controller 31 can provide the toilet unit 25 to the location of the first vehicle 1 on demand in accordance with the request for vehicle dispatch. Thus, the server 3 enables a passenger in the first vehicle 1 to use the toilet while moving to the destination. Because the passenger does not need to make a detour to use the toilet, the passenger can move to the destination in a similar situation to waiting for a toilet.

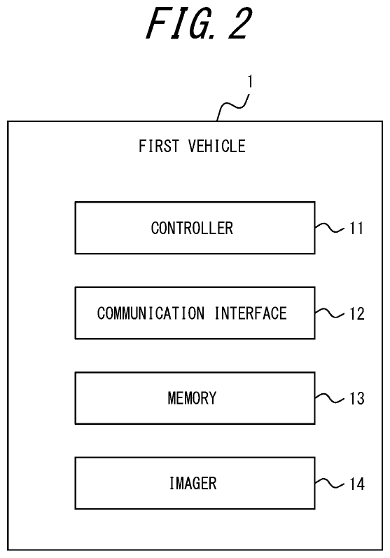

An internal configuration of the first vehicle 1 is described in detail with reference to FIG. 2.

The first vehicle 1 includes a controller 11, a communication interface 12, a memory 13, and an imager 14. The components of the first vehicle 1 are communicably connected to one another via, for example, a dedicated line.

The controller 11 includes, for example, one or more general-purpose processors including a Central Processing Unit (CPU) or a Micro Processing Unit (MPU). The controller 11 may include one or more dedicated processors that are dedicated to specific processing. The controller 11 may include one or more dedicated circuits instead of the processor. Examples of dedicated circuits may include a Field-Programmable Gate Array (FPGA) and an Application Specific Integrated Circuit (ASIC).

The communication interface 12 includes, for connecting to the network NW, one or more communication modules that conform to wired or wireless Local Area Network (LAN) standards. The communication interface 12 may include one or more modules conforming to mobile communication standards including the 4th Generation (4G) standard or the 5th Generation (5G) standard. The communication interface 12 may include one or more communication modules conforming to near field communication standards or specifications, including Bluetooth (Bluetooth is a registered trademark in Japan, other countries, or both), AirDrop (AirDrop is a registered trademark in Japan, other countries, or both), IrDA, ZigBee (ZigBee is a registered trademark in Japan, other countries, or both), Felica (Felica is a registered trademark in Japan, other countries, or both), or RFID. The communication interface 12 is configured to transmit and receive any appropriate information via the network NW. Any appropriate information includes location information obtained using, for example, GPS.

The memory 13 may be, but is not limited to, a semiconductor memory, a magnetic memory, or an optical memory. The memory 13 may function as, for example, a main memory, an auxiliary memory, or a cache memory. The memory 13 may store information resulting from analysis or processing performed by the controller 11. The memory 13 may also store various types of information, etc., regarding operations and control of the first vehicle 1. The memory 13 may include a system program, an application program, embedded software, and the like.

The imager 14 includes a camera and can capture an image of its surroundings. The imager 14 may store the captured image in the memory 13 or transmit the captured image to the controller 11 for the purpose of analysis.

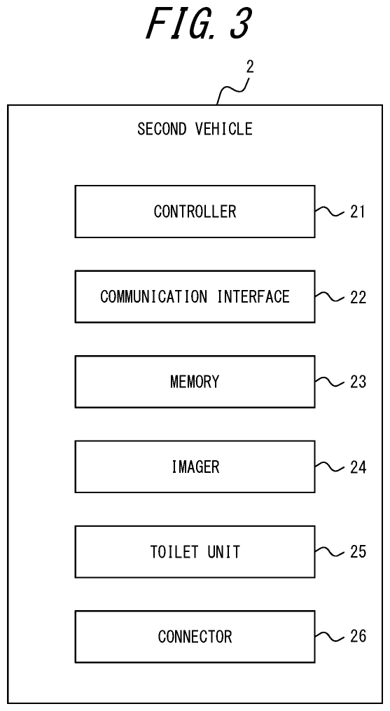

With reference to FIG. 3, an internal configuration of the second vehicle 2 is described in detail.

The second vehicle 2 includes a controller 21, a communication interface 22, a memory 23, an imager 24, the toilet unit 25, and a connector 26. The components of the second vehicle 2 are communicably connected to one another via, for example, a dedicated line.

In the present embodiment, hardware components of the controller 21, the communication interface 22, the memory 23, and the imager 24 are the same as the hardware components of the controller 11, the communication interface 12, the memory 13, and the imager 14 of the first vehicle 1. Therefore, a description thereof is omitted here.

The toilet unit 25 is a facility for excretion that includes a toilet bowl. The toilet unit 25 may further include a hand washing station.

The connector 26 is a coupler for connecting the second vehicle 2 to another vehicle (i.e., the first vehicle 1 in the present embodiment). The connector 26 serves as a bridge. An upper surface of the connector 26 is configured to allow passengers to traverse the connector 26. For example, the upper surface of the connector 26 is flat and wide enough for a user U01 to traverse. The connector 26 may have a handrail for the user U01 to grab. In the present embodiment, the connector 26 is included in the second vehicle 2. However, as an alternative example, the connector 26 may be included in the first vehicle 1.

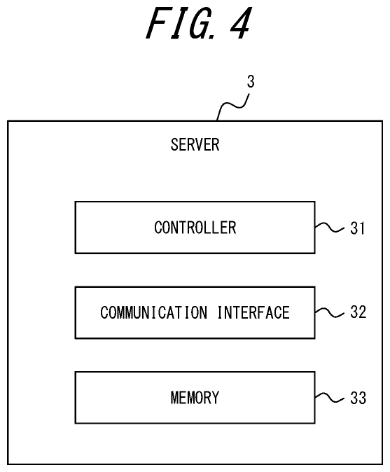

With reference to FIG. 4, an internal configuration of the server 3 is described in detail.

The server 3 includes the controller 31, a communication interface 32, and a memory 33. The components of the server 3 are communicably connected to one another via, for example, a dedicated line.

In the present embodiment, hardware components of the controller 31, the communication interface 32, and the memory 33 are the same as the hardware components of the controller 21, the communication interface 22, and the memory 23 of the second vehicle 2. Therefore, a description thereof is omitted here.

The memory 33 includes a vehicle dispatch request DB as described below. As an alternative example, the vehicle dispatch request DB may be stored in a storage device external to the server 3.

Hereinafter, processing executed in the information processing system S according to the present embodiment will be described in detail. Here, as an example, a scenario in which a user U01 boards a travelling first vehicle 1 as a passenger will be described.

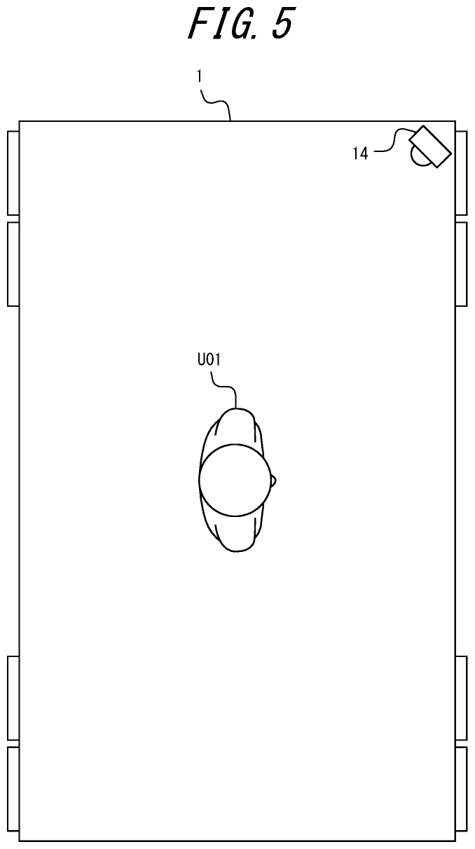

As illustrated in FIG. 5, the imager 14 of the first vehicle 1 captures the user U01 in the vehicle. The imager 14 transmits the captured image to the controller 11. The controller 11 analyzes the captured image to recognize the motion, the posture, the expression, or the like of the user U01. The memory 13 stores in advance a reference motion, a reference posture, a reference expression, or the like that are indicative of at least one of an urge to urinate and an urge to defecate. Referring to the memory 13, the controller 11 determines whether the motion, the posture, or the expression recognized for the user U01 matches the reference motion, the reference posture, or the reference expression stored in the memory 33. As such, the first vehicle 1 determines whether the user U01 has at least one of an urge to urinate and an urge to defecate. For image analysis, any appropriate image analysis method such as machine learning may be employed.

As an alternative example, the first vehicle 1 may have a button in the vehicle for the user U01 to press when the user U01 has at least one of an urge to urinate and an urge to defecate. The first vehicle 1, upon detecting that the button has been pressed, may detect that the user U01 has at least one of an urge to urinate and an urge to defecate. As another alternative example, the first vehicle 1 may detect that the user U01 has at least one of an urge to urinate and an urge to defecate in accordance with biological information obtained from the user U01. For example, the first vehicle 1 may detect that the user U01 has at least one of an urge to urinate and an urge to defecate when a size of the urinary bladder of the user U01 exceeds a predetermined value. As yet another alternative example, the first vehicle 1 may detect that the user U01 has at least one of an urge to urinate and an urge to defecate in accordance with sound information obtained from the user U01. For example, the first vehicle 1 may detect that the user U01 has spoken a phrase, such as “I want to go to the toilet” to detect that the user U01 has at least one of an urge to urinate and an urge to defecate.

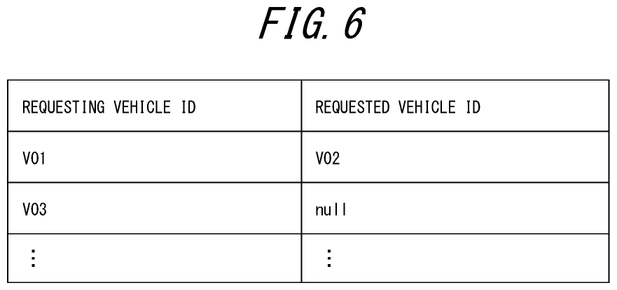

The first vehicle 1, upon detecting that the user U01 has at least one of an urge to urinate and an urge to defecate, transmits to the server 3 a request for vehicle dispatch of a vehicle including a toilet unit. The first vehicle 1 transmits location information for the first vehicle 1 to the server 3, together with the request for vehicle dispatch. As an alternative example, the location information for the first vehicle 1 may be transmitted to the server 3 separately from the request for vehicle dispatch. The server 3 stores, as a requesting vehicle ID, an ID for the first vehicle 1 (corresponding to “V01” in FIG. 6) that has transmitted the request for vehicle dispatch, as illustrated in the vehicle dispatch request DB in FIG. 6.

The server 3, in advance, stores identification information for one or more vehicles that include a toilet unit, in the memory 33. The server 3 identifies from the memory 33 a second vehicle 2 that is closest to a location corresponding to the location information for the first vehicle 1. In this situation, the server 3 registers an ID for the second vehicle 2 (corresponding to “V02” in FIG. 6) as a requested vehicle ID in association with the ID for the first vehicle 1, as illustrated in the vehicle dispatch request DB in FIG. 6.

The server 3 instructs the second vehicle 2 to move to the location of the first vehicle 1. The server 3 may periodically obtain location information for the first vehicle 1 from the first vehicle 1 and transmit the location information to the second vehicle 2.

Before the second vehicle 2 arrives at the location of first vehicle 1, the server 3 may notify the first vehicle 1 of the time required for the second vehicle 2 to arrive at the location of the first vehicle 1. For example, the server 3 may calculate the required time [h] by dividing the distance [km] between the first vehicle 1 and the second vehicle 2 by a value obtained by subtracting the moving speed [km/h] of the first vehicle 1 from the moving speed [km/h] of the second vehicle 2.

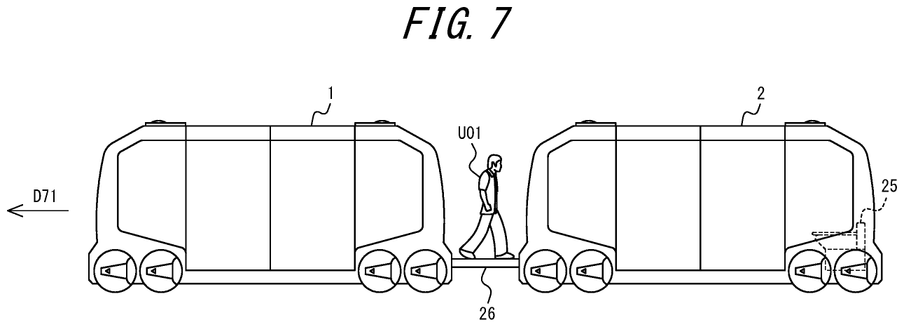

The second vehicle 2, upon arriving in the vicinity of the first vehicle 1, determines whether the first vehicle 1 is moving (i.e., travelling). As illustrated in FIG. 7, here the first vehicle 1 is moving in the direction D71. The second vehicle 2, upon determining that the first vehicle 1 is moving, substantially synchronizes (i.e., substantially matches) the moving speed of the second vehicle 2 with the moving speed of the first vehicle 1. The second vehicle 2 connects to the first vehicle 1 via the connector 26. As an alternative example, the second vehicle 2 may separate the toilet unit 25 from the second vehicle 2 to connect the toilet unit 25 to the first vehicle 1.

The connector 26 is configured such that the user U01 of the first vehicle 1 is able to traverse the connector 26. Thus, the user U01 boarding the first vehicle 1 can move to the second vehicle 2 over the connector 26. The user U01 uses the toilet unit 25 provided in the second vehicle 2.

The second vehicle 2 determines whether use of the toilet unit 25 by the user U01 has ended. The second vehicle 2, upon identifying that use of the toilet unit 25 has ended, transmits a use end notification to the server 3. The server 3, upon receiving the use end notification, instructs the second vehicle 2 to separate from the first vehicle 1.

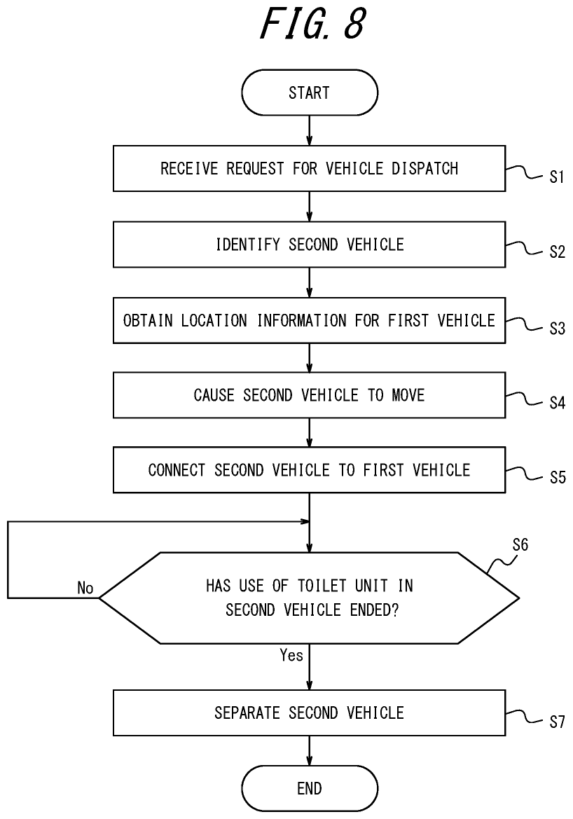

A control method performed by the server 3 will be described with reference to FIG. 8.

In Step S1, the server 3 receives the request for vehicle dispatch from the first vehicle 1. In this situation, the request for vehicle dispatch may include location information for the first vehicle 1.

In Step S2, the server 3 identifies, as a vehicle to be dispatched, the second vehicle 2 at a location closest to the first vehicle 1.

In Step S3, the server 3 periodically obtains the location information for the first vehicle 1.

In Step S4, the server 3 causes the second vehicle 2 to move to the location of the first vehicle 1.

In Step S5, the server 3 connects the second vehicle 2 to the first vehicle 1. In this situation, the user U01 of the first vehicle 1 can use the toilet unit 25 in the second vehicle 2.

In Step S6, the server 3 determines whether use of the toilet unit 25 in the second vehicle 2 has ended.

If the result of the determination is “No” in Step S6, the server 3 executes step S6 again.

If the result of the determination is “Yes” in Step S6, the server 3 separates the second vehicle 2 from the first vehicle 1, in Step S7.

As has been described, according to the present embodiment, the server 3 is communicably connected to the first vehicle 1 and the second vehicle 2 including the toilet unit 25. Upon receiving the request for vehicle dispatch from the first vehicle 1, the controller 31 responds to the request for vehicle dispatch and identifies the second vehicle 2. The controller 31, upon obtaining the location information for the first vehicle 1, causes the second vehicle 2 to move to the location corresponding to the location information. According to this configuration, the controller 31 can provide the toilet unit 25 to the location of the first vehicle 1 in accordance with the request for vehicle dispatch. Thus, the passenger on the first vehicle 1 can use the toilet while moving to the destination.

Moreover, according to the present embodiment, the controller 31 connects the second vehicle 2 to the first vehicle 1. According to this configuration, the passenger on the first vehicle 1 can easily use the toilet unit 25.

Moreover, according to the present embodiment, the connector 26 between the first vehicle 1 and the second vehicle 2 is configured to enable the passenger on the first vehicle 1 to traverse the connector 26. According to this configuration, the passenger on the first vehicle 1 can directly move to the second vehicle 2 over the connector 26 to use the toilet unit 25.

According to the present embodiment, the controller 31, upon detecting that the first vehicle 1 is moving, synchronizes the moving speed of the second vehicle 2 with the moving speed of the first vehicle 1 to connect the second vehicle 2 to the first vehicle 1. According to this configuration, the controller 31 can reduce an impact caused when connecting the second vehicle 2 to the first vehicle 1, thereby improving safety for the passenger.

Moreover, according to the present embodiment, the controller 31, upon detecting that use of the toilet unit 25 has ended, separates the second vehicle 2 from the first vehicle 1. According to this configuration, since the controller 31 reclaims the second vehicle 2 that is no longer required, the controller 31, when receiving a request for vehicle dispatch from another vehicle, can rapidly dispatch the second vehicle 2 to the another vehicle.

According to the present embodiment, the controller 31 identifies the second vehicle 2 at a location closest to the first vehicle 1. According to this configuration, the controller 31 can shorten the time required to dispatch the second vehicle 2 to the first vehicle 1, thereby reducing the waiting time for the passenger on the first vehicle 1.

Moreover, according to the present embodiment, before the second vehicle 2 arrives at the first vehicle 1, the controller 31 notifies the first vehicle 1 of the time required for the second vehicle 2 to arrive at the first vehicle 1. According to this configuration, the controller 31 notifies the passenger on the first vehicle 1 that the second vehicle 2 is coming, thereby giving the passenger a sense of security.

While the present disclosure has been described with reference to the drawings and examples, it should be noted that various modifications and revisions can be implemented by those skilled in the art based on the present disclosure. Accordingly, such modifications and revisions are included within the scope of the present disclosure. For example, functions or the like included in each step can be rearranged without logical inconsistency, and a plurality of steps can be combined into one or divided.

For example, in the above embodiment, a program that executes all or some of the functions or processing of the server 3 may be recorded on a computer readable recording medium. The computer readable recording medium includes a non-transitory computer readable medium and may be a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may also be provided as a program product. The present disclosure can also be implemented as a program executable by a processor.

1. A server configured to communicably connect to a first vehicle and a second vehicle that comprises a toilet unit, the server comprising a controller configured to:
receive from the first vehicle a request for vehicle dispatch;
identify the second vehicle in response to the request for vehicle dispatch;
obtain location information for the first vehicle; and
cause the second vehicle to move to a location corresponding to the location information.

2. The server according to claim 1, wherein the controller is configured to cause the second vehicle to connect to the first vehicle.

3. The server according to claim 2, wherein a connector between the first vehicle and the second vehicle is configured to enable a passenger on the first vehicle to traverse the connector.

4. The server according to claim 2, wherein causing the second vehicle to connect to the first vehicle comprises, upon detecting that the first vehicle is moving, synchronizing a moving speed of the second vehicle with a moving speed of the first vehicle to cause the second vehicle to connect to the first vehicle.

5. The server according to claim 2, wherein the controller, upon detecting that use of the toilet unit has ended, causes the second vehicle to separate from the first vehicle.

6. The server according to claim 1, wherein identifying the second vehicle comprises identifying the second vehicle at a location closest to the first vehicle.

7. The server according to claim 1, wherein the controller is configured to notify the first vehicle of a time required for the second vehicle to arrive at the first vehicle, before the second vehicle arrives at the first vehicle.

8. A non-transitory computer readable medium storing a program configured to cause a computer, communicably connected to a first vehicle and a second vehicle that comprises a toilet unit, to execute operations, the operations comprising:
receiving from the first vehicle a request for vehicle dispatch;
identifying the second vehicle in response to the request for vehicle dispatch;
obtaining location information for the first vehicle; and
causing the second vehicle to move to a location corresponding to the location information.

9. The non-transitory computer readable medium according to claim 8, wherein the program is configured to cause the computer to cause the second vehicle to connect to the first vehicle.

10. The non-transitory computer readable medium according to claim 9, wherein a connector between the first vehicle and the second vehicle is configured to enable a passenger on the first vehicle to traverse the connector.

11. The non-transitory computer readable medium according to claim 9, wherein causing the second vehicle to connect to the first vehicle comprises, upon detecting that the first vehicle is moving, synchronizing a moving speed of the second vehicle with a moving speed of the first vehicle to cause the second vehicle to connect to the first vehicle.

12. The non-transitory computer readable medium according to claim 9, wherein the program is configured to cause the computer to separate the second vehicle from the first vehicle, upon detecting that use of the toilet unit has ended.

13. The non-transitory computer readable medium according to claim 8, wherein identifying the second vehicle comprises identifying the second vehicle at a location closest to the first vehicle.

14. The non-transitory computer readable medium according to claim 8, wherein the program is configured to cause the computer to notify the first vehicle of a time required for the second vehicle to arrive at the first vehicle, before the second vehicle arrives at the first vehicle.

15. A control method performed by a server communicably connected to a first vehicle and a second vehicle that comprises a toilet unit, the control method comprising:
receiving from the first vehicle a request for vehicle dispatch;
identifying the second vehicle in response to the request for vehicle dispatch;
obtaining location information for the first vehicle; and
causing the second vehicle to move to a location corresponding to the location information.

16. The control method according to claim 15, further comprising causing the second vehicle to connect to the first vehicle.

17. The control method according to claim 15, wherein causing the second vehicle to connect to the first vehicle comprises, upon detecting that the first vehicle is moving, synchronizing a moving speed of the second vehicle with a moving speed of the first vehicle to cause the second vehicle to connect the first vehicle.

18. The control method according to claim 15, further comprising separating the second vehicle from the first vehicle upon detecting that use of the toilet unit has ended.

19. The control method according to claim 15, wherein identifying the second vehicle comprises identifying the second vehicle at a location closest to the first vehicle.

20. The control method according to claim 15, further comprising notifying the first vehicle of a time required for the second vehicle to arrive at the first vehicle, before the second vehicle arrives at the first vehicle.
